(19) United States
(12) Patent Application Publication
(10) Pub. No.: US 2004/0218727 A1
(43) Pub. Date: Nov. 4, 2004

(54) Mammography compression cushion system

(75) Inventor: Norman A. Shoenfeld, Livingston, NJ (US)

Correspondence Address: BERNHARD P. MOLLDREM, JR., 224 HARRISON STREET, SUITE 200, SYRACUSE, NY, 13202, US

(73) Assignee: S&S X-Ray Products, Inc.

(21) Appl. No.: 10/427,329

(22) Filed: May 1, 2003

(51) Int. Cl. G03C 5/16

(52) U.S. Cl. 378/167

(57) ABSTRACT

A reusable flat radiolucent compression cushion is placed on one or both compression surfaces of a mammography machine. The cushion has a cover or enclosure of a radiolucent bio-compatible plastic film, e.g., polyurethane film, and a flat core of a radiolucent plastic foam material, e.g., cross-linked polyethylene foam. The plastic foam material and the film of the enclosure are substantially free of visible artifacts at the low radiological energies used during mammography, so that the breast tissues image clearly. Outside the imaging area, there are fastener strips or patches, e.g., Velcro, for removably attaching the cushion to the associated compressive surface. The mammography compression cushions are light weight and can be easily stored in a convenient shelf or drawer near the mammography machine. The cushions can be easily cleaned with a mild soap and water, and may be disinfected using any standard hospital disinfecting solution.

### BACKGROUND OF THE INVENTION

This invention relates to x-ray diagnosis techniques, and is more especially related to mammography, that is, x-ray imaging that creates a detailed image of a woman's breast. The invention is also concerned with a cushion that alleviates the pain and discomfort of the compression or flattening of the breast that is carried out as a part of the mammography procedure.

Mammography is a type of x-ray imaging used to create images of the human breast. Mammography uses a low-dose, low-energy x-ray radiation to image the breast on a high-contrast, high-resolution film or onto a sensitive solid-state x-ray imaging plate. This procedure is highly recommended as a means for early detection and successful treatment of breast cancer. Mammography can also show changes in the breast tissues, by comparing images with a series of images taken earlier, and these tissue changes can be detected by mammography even when they are not apparent by palpation. Screening mammography examinations are carried out on asymptomatic women as a means of very early detection. Diagnostic mammography examination is carried out if a woman has had a breast complaint or if an abnormality has been detected earlier, such as by means of a screening examination. Either type of mammography examination involves taking several views of the breast tissue for each breast.

The mammography procedure is carried out using a special x-ray machine, with compression plates or surfaces that are carefully positioned against the woman's breast and gently moved towards one another to compress and flatten the breast so that the maximum amount of tissue can be imaged and examined. Typically, one compression surface is a film cassette that contains the x-ray film, and the other compression surface is a clear plastic paddle. After the technologist has positioned the patient, the paddle is pushed gently down against the breast to flatten it, and then the x-ray image is taken through the paddle and the compressed or flattened breast to expose the film (or solid state imager) in the cassette. The various tissues in the breast absorb x-rays differently, and the mammography x-ray image shows such features as fat, fibroglandular tissue, breast ducts, and connective tissues. Abnormalities such as microcalcifications, masses, cysts, and tumors will also become visible. Because the breast tissues are all soft tissues, a very low energy x-ray radiation is used so that the different tissues will image differently.

Breast compression is a necessary step to flatten the breast so that the maximum amount of breast tissue can be imaged and examined. Breast compression can cause pain or other discomfort in women, even though the technician will attempt to keep the time short that the breast is being compressed. Many women also find that the compressive surfaces are cold against their breast. Typically, a number of views are taken for each breast, i.e., a caudocranial view, mediolateral view, lateromedial view, and oblique latermedial view(s), and the breast has to undergo compression for each image.

Recently, various mammography pads or cushions have become available to reduce the discomfort mentioned just above. These pads are typically placed on one or the other (or both) of the cassette and the compression paddle. The current practice in use of mammography pads or cushions involves use of one-use disposable open-cell foam plastic pads that are attached temporarily onto the compression surface(s) using a double-sided tape. One such mammography pad is described in Pat. Appln. Pub. No. US 2003/0007597 (Higgins et al.), in which the pad is formed of a sheet of an elastomeric open cell foam, such as a polyolefin or polyurethane, chosen for its soft tactile feel and for its good radiolucent characteristics. Such pad is about one eighth to one-half inch thick. The pads are open cell foam, and are not washable or cleanable, and thus have to be discarded after each patient. Because each pad costs about $4.00 to $8.00, the cost of performing a mammography increases by that amount, or by twice that amount where both upper and lower pads are used. Because the compression pad is optional, this cost is not covered by insurance and has to be borne by the patient or by the facility. As a result, and due to the limited reimbursement for mammography studies, most facilities do not offer this to patients due to the prohibitive expense of disposables.

The open-cell one-use mammography pads are attached to the mammography machine with an adhesive, which can leave a residue, and can be a source for imaging artifacts, as particles or fibers may cling to adhesive residue. It is also costly to verify the absence of artifacts at the facility; because each pad is intended to be discarded, a quality check would be required as an extra image for each patient, which could make the cost of imaging prohibitive. Consequently, the mammography clinic has to rely on quality assurance steps, if any, that are carried out at manufacture.

### OBJECTS AND SUMMARY OF THE INVENTION

Accordingly, it is an object of the present invention to provide a pad or cushion for use in mammography that avoids the drawbacks of the prior art, as discussed above.

It is another object to provide a mammography compression cushion that is reusable and can be readily cleaned and disinfected.

It is a further object to provide a mammography compression cushion that permits a calibration imaging to check for artifacts within the pad, and because the image can be kept on file, permits the radiologist to account for any imperfections in a given cushion for subsequent use in mammography.

It is still another object to provide a mammography compression cushion that provides satisfactory comfort to the patient, and which is does not pose a significant financial burden for the patient or the facility.

In accordance with an aspect of the present invention, a reusable flat radiolucent compression cushion is provided, in which the cushion is placed upon one or both compressive surface of a pair of surfaces between which the patient's breast is flattened by compression to improve radiographic imaging of tissues in the breast. A center portion of the compression surface, that is the position at which the breast is held against the compressive surface, defines an imaging area. The cushion has a cover or enclosure with a front (top) layer and a back (bottom) layer, both of a radiolucent bio-compatible plastic film, e.g., polyurethane film, and has a flat core of a radiolucent plastic foam material, e.g., cross-linked polyethylene foam. The foam core is sealed in the enclosure between the front and back layers. The plastic foam material deforms under compression to cushion the patient's breast, so that she experiences noticeably less discomfort from squeezing her breast. The foam core restores itself to its original flat shape after compression. The plastic foam material and the film of the enclosure are substantially free of visible artifacts at the radiological energies used during mammography, so that the breast tissues image clearly. At the sides, i.e., at positions outside the imaging area, there are fastener strips or patches, i.e., portions disposed on the cushion outside of the imaging area for removably attaching the cushion to the associated compressive surface. These may be mating hook-and-loop fastener strips, such as Velcro. They may also be in the form of a removable adhesive (such as glue or double-sided adhesive tape).

The mammography compression pad(s) of this invention have been designed to make breast compression more tolerable to the patient, without significantly increasing the cost of the procedure. Because the compression pads can be cleaned, sterilized, and reused, they are much more cost effective to use than the prior, disposable mammography pads. Therefore, mammography pads can be incorporated into routine mammography for all patients. The inner foam core, contained inside the outer polyurethane film shell, is designed to return to its original shape after compression, without developing a shape memory. Because the mammography cushions are designed for a long life of continued reuse, they are dimensioned for the specific make and model of mammography machine in the clinic. Consequently, they can be provided with Velcro closure material (or another attachment system) with a mating Velcro material being secured onto the compression surfaces (of the cassette and/or paddle) outside the imaging area.

The compression pads may also have a front panel to cushion the patient's ribs where she pushes against the front edge of the compression surfaces, i.e., the front edge of the cassette or paddle.

The polyurethane film and the flat core layer of cross-linked polyethylene foam have been found to be radiolucent at the low energies used for mammography, and produce no artifacts in the mammographic image.

The mammography cushion is placed on each of the two compression surfaces of the mammography machine. The cushions are manufactured in a variety of patterns, to facilitate attachment onto the given model of mammography machine. In addition, a thin compressive foam bar can be used that is positioned along the front surface of the main cushion, in the region where the mammography machine presses against the patient's ribs. This foam bar can be thinner than the main cushion, and as it is outside the imaging area its radiolucency is not critical. The foam bar provides some cushioning, but also allows the maximum amount of breast tissue to be imaged.

The mammography compression cushions of this invention are light in weight and can be easily stored in a convenient shelf or drawer near the mammography machine. The cushions can be easily cleaned with a mild soap and water, and may be disinfected using any standard hospital disinfecting solution, such as Cavicide ™ or T-Spray ™.

The mammography compression cushions of this invention are mounted on the specified mammography machine for which intended, using the Velcro or similar strips, or an alternative adhesive means. The cushion is first placed so that it is centered on the imaging area, and slightly overlaps the edges of the imaging surface. The smooth, folded-over edge of the cushion is considered the front edge, and is directed toward the front of the machine, i.e., where the patient's chest wall will contact the machine. The cushions that have the additional foam bar will have that portion also facing towards the patient. An alternative configuration has two separate pieces of foam abutting within the polyurethane envelope, and the “bend” at the junction of the main cushion and the front foam bar occurs at this interface. After placement on the machine, the cushion is secured to it by use of the Velcro strips (or other adhesive means, i.e., removable double-sided adhesive tape, in an area outside the imaging area). The Velcro is pre-attached to the cushion, in an area that will be outside the area where the breast tissues are imaged. There is an adhesive strip on the mating Velcro strips, and release covers are removed from these so they can be adhesively attached to the cassette or paddle, i.e., compressive surfaces, outside the imaging area. Similarly, an upper cushion should be placed on the compressive paddle portion of the mammography machine, and similarly secured. The cushion placement procedure can be facilitated by centering the cushions on the imaging and compressive surfaces, applying slight compressive force to hold the cushions in place, and then applying the Velcro strips outside the imaging field.

The cushions can be easily removed from the machine after a sequence of mammography images has been taken for a given patient, and the cushions can be cleaned and disinfected prior to use with a subsequent patient. A similar cleaning protocol is suggested again before the use of the cushion.

Any question of cushion-induced artifact can be ruled out immediately by taking a test image using the cushions alone. The test image need only be taken once for a given pair of cushions. However, it may be prudent to take a test image prior to a given sequence of images to rule out artifacts which may be caused by foreign matter that may be trapped between the cushion and the machine. This procedure is recommended both for film-screen and for when a solid-state x-ray imaging plate is used.

The urethane film sheath or covering of the cushion is tough and durable, and can withstand rough handling. The usual precautions of removing rings and wrist watches, should be observed, and sharp instruments should be avoided as these may puncture the cushion and may interfere with cleaning and disinfection.

The above and many other objects, features, and advantages of this invention will become apparent from the ensuing description of a selected preferred embodiment, which is to be considered in connection with the accompanying Drawing.

### BRIEF DESCRIPTION OF THE DRAWING

FIG. 1 is a perspective view of a mammography machine with which the compression cushions of this invention may be advantageously employed.

FIG. 2 is a perspective view of a cassette and lower compression surface of the machine with a lower compression cushion according to one preferred embodiment of this invention.

FIG. 3 is a cross-section of a portion of the cushion of this invention.

FIG. 4 is a perspective view of a compression paddle of the machine with an upper cushion according to one preferred embodiment of this invention.

FIG. 5 is a top plan view of the lower compression cushion of this embodiment.

FIG. 6 is a side elevation taken at 6-6 of FIG. 5.

FIG. 7 is a front elevation taken at 7-7 of FIG. 5.

### DETAILED DESCRIPTION OF THE PREFERRED EMBODIMENT

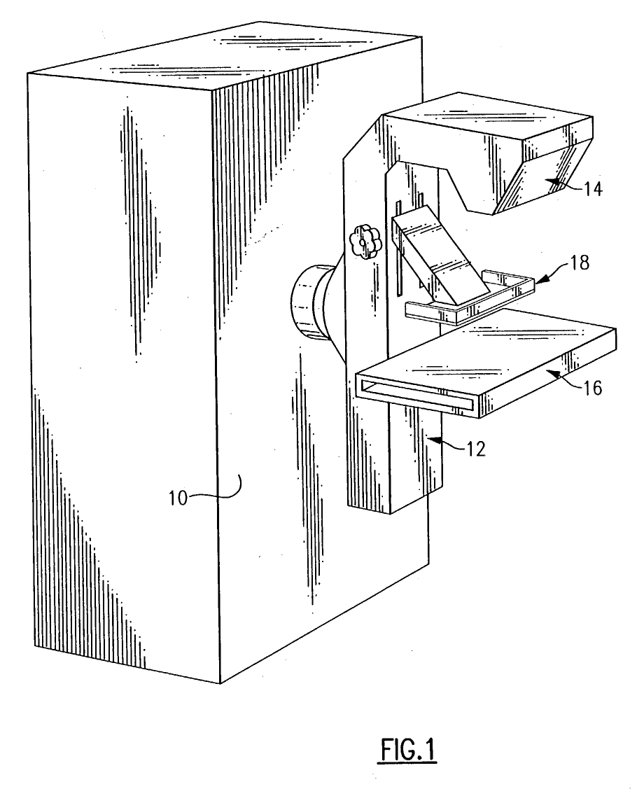

With reference to the Drawing, and initially to FIG. 1, a mammography machine 10, for conducting screening or diagnostic mammography imaging, has a gantry pillar 12 that can be rotated about a horizontal axis, with an x-ray source or generator 14 positioned at an upper end of the gantry 12. The gantry can be adjusted so that one or both of the patient's breasts can be imaged at any of the usual aspects, i.e., craniocaudal, mediolateral, lateromedial, and oblique mediolateral. The generator 14 is preferably of a type that emits a highly controllable low-energy x-ray, which is suitable for providing good contrast among the soft tissues of the human breast.

A flat, box-like cassette holder 16 is positioned on the gantry 12, and serves both as a holder for an x-ray receptive plate (such as a film holder or a solid-state flat panel imager), and also a surface on which the patient's breast can be positioned for imaging. The cassette holder 16 may be slidably positioned up and down along the gantry according to the physique of the individual patient. A compression paddle 18 is situated on the gantry 12 above the cassette holder 16, and is slidably movable along the gantry to compress and flatten the patient's breast on the top surface of the cassette holder. Because the upper surface of the cassette holder 16 and the lower surface of the paddle 18 are hard, compression or squeezing of the breast between them can be quite uncomfortable for the patient, and sometimes rather painful. In order to minimize the discomfort of breast compression, mammography compression cushions according to this invention can be used.

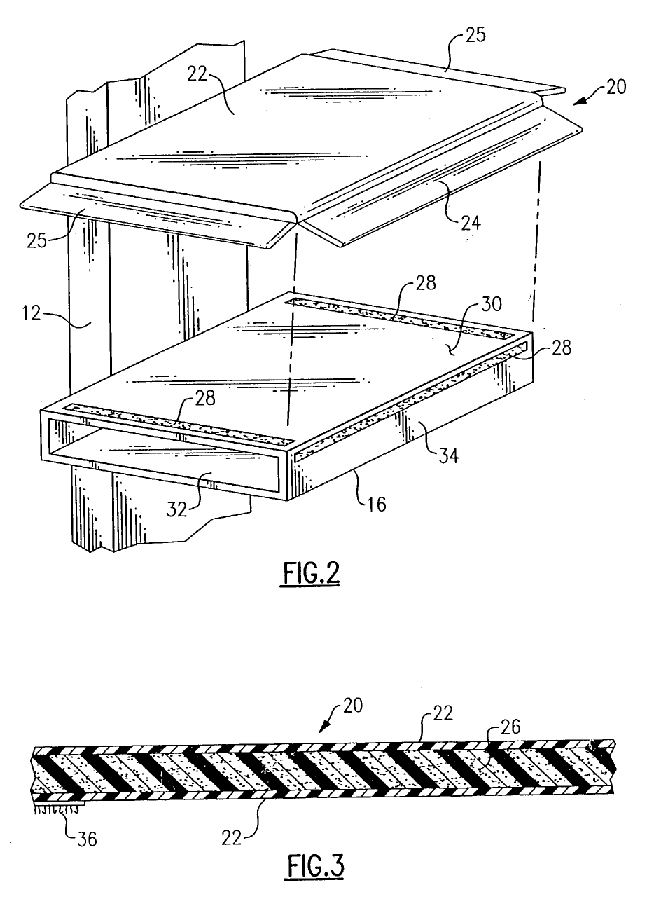

As shown in FIG. 2, a generally flat, thin mammography compression cushion 20 of this invention can be positioned onto the cassette holder 16, i.e., onto the lower compression surface. As shown with further reference to FIG. 3, the mammography compression cushion 20 has a skin or enclosure 22 of a thin plastic film, in this embodiment, a polyurethane film. This material is selected because of its high biocompatibility with human skin, its flexibility and resilience, and its toughness, as it will need to withstand several hundred cycles of use, each followed by a wash and disinfect operation. The cushion may have an optional front panel or strip 24 that cushions the front portion of the cassette holder 16 which presses against the patient's rib cage. There may also be skirts or side panels 25 of the polyurethane film that may contact against the sides of the cassette holder. There is a foam core 26 formed of a highly radiolucent material, in this embodiment, cross-linked polyethylene foam. This can be a nominal ¼ to ½ inch in thickness, although thickness is not critical.

A set of Velcro strips 28 are applied onto the cassette holder 16 on the front, sides, and/or top surface, in an area outside the imaging area. That is, the Velcro strips 28 are attached outside the imaging area where the breast tissues are pressed against the cassette holder. The Velcro strips may be applied onto the edges at a top surface 30 of the cassette 16, or may be applied onto sides 32 and/or a front 34 of the cassette holder 16. As shown in FIG. 3, the core 26 is sandwiched between an upper layer and a lower layer of the film or skin 22. The core 26 may be a nominal one-half inches thick, depending upon the machine and other factors. There is a mating portion 36 of the Velcro bonded onto the lower film layer 22 to mate with the Velcro or other fastener material on the cassette holder 16, and this is used to secure the compression pad 20 in place during a mammography procedure.

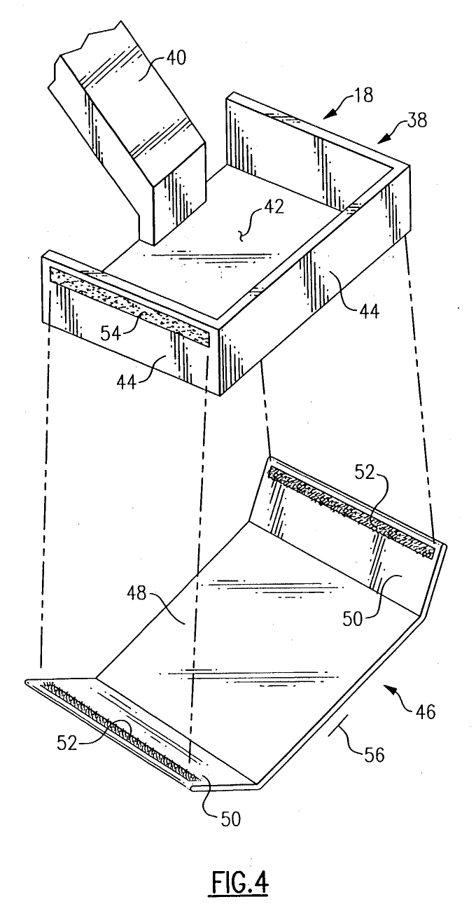

FIG. 4 illustrates the compression paddle 18 which is movable towards the cassette 16 and serves as an upper compressive surface. In this case, the paddle 18 has a box-like compression element 38, and a support arm 40 that is slidably attached onto the gantry 12. The paddle has a flat base wall 42, here generally rectangular in shape, as well as front and side walls 44. An upper compression pad 46, formed similarly to the compression pad 20 of a radiolucent foam core and a polyethylene enclosure or skin, has a central panel 48 that is held onto the flat base wall 42. In this embodiment there are side panels 50 that removably attach to the compression element, i.e., with Velcro or the like. Here Velcro strips 52 are shown bonded to the cushion or pad 46, as well as mating Velcro strip(s) 54 on the side and/or front walls 44 of the paddle. The strips may be on the panel 48 or the side panels 50, or both but outside the imaging area. Here a smooth front edge 56 of the upper compression cushion 42 is formed by a fold-back of the polyurethane film skin or enclosure. The folded edge 56 faces forward, i.e., towards the patient.

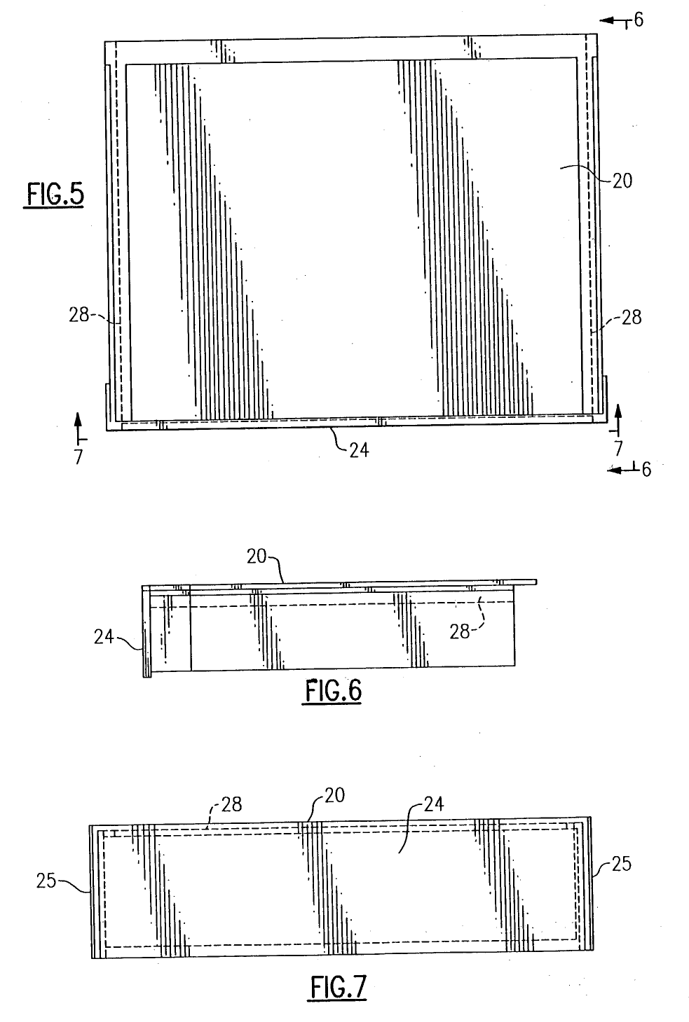

Detail of the compression pad of one embodiment is shown in FIG. 5, with additional references to FIGS. 6 and 7. The cushion 20 is of a generally rectangular shape dimensioned to match the cassette holder of a particular mammography machine. The positions of the front panel 24 and Velcro strips 28 are shown here also, as are the side panels 25. Each of these cushions may be provided with identification data, i.e., serial numbers, which may be in the form of a scannable bar code. This will serve to identify the cushion for calibration purposes, in the case any blemish may be suspected of producing an artifact. Both the lower and upper cushions may be provided with a front panel to cushion the patient's ribs, or may be provided without the front panel. Also, while Velcro strips are used in this embodiment, other fastener systems may be used, provided they permit cleaning, disinfection, and reuse of the cushions.

The mammography procedure for producing a series of breast images then involves placing mammography compression cushions upon both the upper and lower compression surfaces, positioning the patient against the mammography machine, and gently closing the compression paddle to flatten the breast. Then the x-ray generator is energized to expose the film or solid state imager. This is repeated for a number of orientations for each breast, to image the tissues in different planes, and may include specialized views to examine regions of interest. After the series is completed, the pads or cushions are removed from the machine, and are washed using water and a mild soap or detergent, followed by a disinfection using a standard hospital disinfectant. Thereafter, the cushion can be reused, or stored for later reuse. A calibration exposure can be taken through the cushions without human tissue, for the purpose of ensuring that the cushions do not produce any artifacts or false tissue structure on the x-ray images.

Cross-linked polyethylene foam has been selected for the preferred embodiment because of its cushioning comfort, resilience, and radiolucency at the low powers used for mammography. However, other foams could be used for the core of the cushion. Likewise, other plastic films besides polyurethane film could be used for the enclosure.

While the invention has been described hereinabove with reference to selected preferred embodiments, it should be recognized that the invention is not limited to those precise embodiments. Rather, many modification and variations would present themselves to persons skilled in the art without departing from the scope and spirit of this invention, as defined in the appended claims.

I claim:

1. Reusable flat radiolucent compression cushion for use in mammography in which the cushion is placed upon a compressive surface of a pair of surfaces between which a patient's breast is flattened by compression to improve radiographic imaging of tissues in the breast, the position of the breast on the compressive surface defining an imaging area, the cushion comprising an enclosure having a front layer and a back layer of a radiolucent plastic film, a flat core of a radiolucent plastic foam material that is sealed in said enclosure between said front and back layers; said plastic foam material deforming under compression to cushion the patient's breast, and restoring itself to its flat shape after compression; said plastic foam material being substantially free of visible artifacts at radiological energies used during mammography; and fastener portions disposed on said cushion outside of said imaging area for removably attaching said cushion to the associated compressive surface.

2. The reusable compression cushion of claim 1 wherein a compression plate defining said compressive surface has a main surface against which said breast is compressed, and a proximal edge which pushes against the patient's ribs, and wherein the cushion has a main cushion portion placed upon said main surface and a front panel that is placed upon said proximal edge.

3. The reusable compression cushion of claim 1 wherein said fastener portions include hook-and-loop fabric fasteners that are positioned adjacent side edges of said cushion.

4. The reusable compression cushion of claim 3 further comprising mating hook-and-loop fasteners attached onto the associated compressive surface.

5. The reusable compression cushion of claim 1 wherein said core is a cross-linked polyethylene foam.

6. The reusable compression cushion of claim wherein said enclosure is formed of a polyurethane film.

7. A process for taking a mammography image of a patient's breast using a mammography machine in which the patient's breast is flattened by compression between first and second facing compressive plates, and an image is taken of the flattened breast using low-energy x-ray radiation to image tissues within the breast, the breast defining an imaging area on the compressive plates; the process comprising applying to at least one of said compressive plates a mammography compression cushion which includes an outer shell of a radiolucent plastic film and a flat core of a radiolucent plastic foam material sealed within said shell, and fastener strips disposed on the cushion outside said imaging area for removably attaching the cushion to the associated compressive plate; compressing the breast between said compressive plates; creating said x-ray mammography image; releasing said compressive plates from the breast; removing said cushion from the associated compressive plate; and washing and disinfecting said cushion for subsequent re-use.

8. The process of claim 7, wherein the outer shell of said cushion is formed of a polyurethane film.

9. The process of claim 7, wherein the core of said cushion is formed of a cross-linked polyethylene foam.

10. The process of claim 7, wherein a second mammography cushion is positioned on the other of said compressive plates, the second mammography cushion including an outer shell of a radiolucent plastic film and a flat core of a radiolucent plastic resilient foam material.

11. The process of claim 7, wherein said washing and disinfecting is carried out by cleaning with mild soap and water, and disinfecting with a standard hospital disinfecting solution.
